(19) United States
(12) Patent Application Publication
(10) Pub. No.: US 2019/0195305 A1
(43) Pub. Date: Jun. 27, 2019

(54) Haltevorrichtung

(71) Applicant: Robert Bosch GmbH, Stuttgart (DE)

(72) Inventors: Samir Mahfoudh, Buehl (DE); Daniel Mueller, Achern (DE)

(21) Appl. No.: 16/214,554

(22) Filed: Dec. 10, 2018

(30) Foreign Application Priority Data
Dec. 13, 2017 (DE) 10 2017 222 668.4

(51) Int. Cl. F16F 7/12

(52) U.S. Cl. CPC F16F 7/121

(57) ABSTRACT

The invention is based on a holding device (12) for fixing an assembly (10), in particular a pump, to a motor vehicle (14) with an elastomer mount (16) and a fixing element (18) for attaching the elastomer mount (16) in an installation space, in particular a motor vehicle (14), wherein the elastomer mount (16) comprises a substantially annular first holding element (22) and a second holding element (28), wherein the first holding element (22) has an inner region (20) provided to receive the assembly (10), and wherein the second holding element (28) is connected to the first holding element (22) by means of at least one damping element (40), and wherein the fixing element (18) is arranged on the second holding element (28). It is provided that the damping element (40) is arranged mainly in the region of the fixing element (18).

### BACKGROUND OF THE INVENTION

The invention is based on a holding device for fixing an assembly, in particular a pump, to a motor vehicle, and an elastomer mount.

In the design and construction of assemblies, such as for example cooling circuit pumps for a motor vehicle, the dynamic loads which are expected in operation of the motor vehicle and which in particular affect components of the assembly, such as for example the circuit board or pin connections, constitute a challenge for developers in relation to robustness.

Examples here are requirements for the vibration tolerance of the assembly when mounted on an internal combustion engine. A rigid mounting of the assembly or pump on the internal combustion engine entails an undamped transfer of excitation energy to the pump, and hence leads to high vibrational loads on the pump. Normally, such excitation vibrations can be greatly damped by elastic mounts. In addition, the sound transmission from the assembly, which can lead to noise formation in the vehicle interior, constitutes a challenge for developers.

A holder device with an elastomer mount is already known in which the elastomer mount has an inner region for receiving an assembly. It is also known that the elastomer mount has a damping element for decoupling and damping, and a fixing element for attaching the elastomer mount in an installation space, in particular a motor vehicle. With such elastomer mounts, it is provided that the damping element is arranged evenly in the peripheral direction on the elastomer mount.

### SUMMARY OF THE INVENTION

The invention is based on a holding device for fixing an assembly, in particular a pump, to a motor vehicle, with an elastomer mount and a fixing element for attaching the elastomer mount in an installation space, in particular a motor vehicle, wherein the elastomer mount comprises a substantially annular first holding element and a second holding element, wherein the first holding element has an inner region provided to receive the assembly, and wherein the second holding element is connected to the first holding element by means of at least one damping element, and wherein the fixing element is arranged on the second holding element. It is proposed that the damping element is arranged mainly in the region of the fixing element.

The holding device according to the invention has the advantage that a transmission of resonant frequencies and, associated therewith, an undesirable noise transmission from the assembly via the holder device to the motor vehicle interior can be minimized. As well as noise minimization, the holder device according to the invention, as a damping and decoupling element, may advantageously minimize dynamic loads such as for example shaking and vibrational loads which may occur in operation of the motor vehicle. At the same time, a holder device according to the invention may advantageously provide a captive clamping of the assembly. It is furthermore advantageous that the material usage for an elastomer mount according to the invention can be reduced and hence the component costs lowered.

In the context of the present invention, a damping element means in particular an element which has a damping property, i.e. is able because of the damping to reduce the amplitude of vibrations. In distinction from the first or second holding elements, the damping element according to the invention has a higher damping factor, wherein the damping factor is determined from the ratio of input size to output size of the transmission path of the system. According to the invention, this higher damping rate of the damping element may be provided by forming and, alternatively or additionally, by setting specific material properties.

The measures listed in the subclaims lead to advantageous refinements and improvements of the independent features.

The holding device according to the invention or an advantageous refinement is distinguished in that the cross-section of the damping element decreases as the distance from the fixing element increases. Because the damping element is arranged mainly in the region of the fixing element, advantageously a particularly high vibration-insulating and vibration-damping effect can be provided at the point at which the transmission path of resonant frequencies from the assembly to the motor vehicle is at its smallest. Due to the decreasing cross-section of the damping element, the installation space required for the elastomer mount can advantageously be reduced and the necessary material usage reduced to the benefit of costs.

According to a particularly preferred embodiment of the invention, the damping element has a crescent-shaped cross-section and is arranged between the first holding element and the second holding element. Because of the cross-section of the damping element with its tapering ends arranged symmetrically to the fixing element, the vibration damping and decoupling take place evenly in the region of the fixing element, wherein because the cross-section reduces continuously in the direction of the ends, peak stresses which occur usually at cross-section jumps can advantageously be prevented.

According to an advantageous refinement of the invention, it is provided that the first holding element surrounds at least portions of the damping element and, in addition or alternatively, surrounds the second holding element in the tangential direction. Due to the tangential overlap at the outer periphery between the first holding element and the second holding element, advantageously some of the holding force of the elastomer mount on the assembly can be provided by the first holding element. In theory, the first holding element may be divided into two portions. A first portion which is formed so as to be substantially annular and in mounted state lies against the assembly, and a second portion which in the manner of an outer strap at least partially overlaps the damping element and, alternatively or additionally, also the second holding element in the tangential direction.

The vibration-insulating and vibration-damping properties of the damping element may, according to a further refinement of the invention, be provided if the damping element has a plurality of first openings. These openings advantageously allow the damping element to reduce vibrations and provide an effective decoupling between the assembly and the installation space. According to an advantageous embodiment of the invention, it may be provided that the first openings are continuous openings which extend through the entire axial length of the elastomer mount. It is however expressly stated at this point that the invention is not restricted to such an embodiment of the first openings. Thus it is also conceivable that the openings may be formed as recesses open at the edge on one side or as inclusions. According to an advantageous refinement of the invention, it is provided that the cross-sections of the first openings decrease as the distance from the fixing element increases, wherein for comparison of the cross-sections of the first openings, evidently the respective cross-section of the opening in the same radial plane is considered. To optimize the vibration damping and vibration insulation, it may furthermore be provided that the cross-sections decrease continuously as the distance from the fixing point increases. The concept of a plurality of first openings here means in particular a number of between 5 and 50 first openings, wherein the openings are preferably dimensioned such that their diameter corresponds to around half the material thickness of the elastomer mount. Evidently however, the number and form of the first openings may be adapted to the respective peripheral conditions of the system. Thus for example, it is also conceivable that the damping element is formed as a foam or porous material, and hence because of the material structure a plurality of openings may mean a range far greater than 50 first openings.

According to an advantageous embodiment of the invention, it is provided that the first openings have a substantially round cross-section. Such round cross-sections can be produced easily, in particular by extrusion. It is however expressly pointed out here that other cross-sectional forms of the first openings are also conceivable insofar as suitable for providing a vibration-damping and vibration-insulating function. Thus for example it is conceivable that the first openings are formed so as to be trapezoid, wherein because of the geometry, webs remains between the first openings. Such webs may advantageously be configured so as to be particularly elastic, so that the damping element can advantageously minimize vibrations. Evidently, it is also conceivable that the first openings have an oval cross-section. According to a refinement of the invention, it is provided that the first openings each have a similar cross-section or mutually congruent cross-section.

In an advantageous refinement of the invention, the first openings are arranged along a theoretical semi-ellipse. Here it is provided that the respective first openings lie with their central points on this theoretical semi-ellipse.

According to a further advantageous refinement of the invention, it is furthermore provided that the elastomer mount has second openings in the region of the fixing element. By arranging the additional second openings in the region of the fixing element, advantageously the stiffness of the damping element in the vibration transmission region can be lowered. According to an advantageous embodiment, the round cross-section of these second openings also decreases as the distance from the fixing element increases. It is however expressly pointed out here that, with regard to the arrangement and configuration of first openings and second openings, many possible combinations are conceivable. Thus the second openings may also be configured so as to be rectangular or trapezoid. It is essential to the invention only that the damping element is arranged mainly in the region of the fixing element.

According to an advantageous embodiment of the invention, the second holding element has a substantially crescent-shaped cross-section, wherein the term “cross-section”, similarly to the opening cross-section of the first and second openings, may mean the cross-section extending in the radial plane. Such a crescent-shaped design of the second holding element advantageously ensures a load-adapted material usage.

A particularly simple and economic holding device may be provided in particular if the first holding element, the second holding element and the damping element are formed as one piece. Such a one-piece embodiment of the elastomer mount can advantageously be provided if the elastomer mount is produced by extrusion as a hollow body with an inner region suitable for receiving the assembly.

The elastomer mount according to the invention is, in a particularly preferred fashion, suitable for insertion in a holding device which is configured for attaching a corresponding assembly in an installation space, in particular a motor vehicle. Because of its embodiment with a substantially annular first holding element and a second holding element, wherein the first holding element has an inner region which is provided to receive the assembly, and wherein the second holding element is connected to the first holding element by means of at least one damping element, and wherein the second holding element has an interface for arrangement of the fixing element and the damping element is arranged mainly in the region of the interface, the elastomer mount according to the invention can minimize vibrations in a particularly advantageous fashion and at the same time can be produced easily and economically by means of extrusion.

### BRIEF DESCRIPTION OF THE DRAWINGS

Exemplary embodiments of the invention are shown in the figures and explained in more detail in the description below. The drawings show:

FIG. 1 a diagrammatic depiction of a holding device according to the invention with an elastomer mount,

FIG. 2a a diagrammatic sectional depiction of an elastomer mount according to a first embodiment,

FIG. 2b a diagrammatic sectional depiction of an elastomer mount according to a second embodiment,

FIG. 3 a perspective view of a base body produced by extrusion before separation of the elastomer mounts according to the invention.

### DETAILED DESCRIPTION

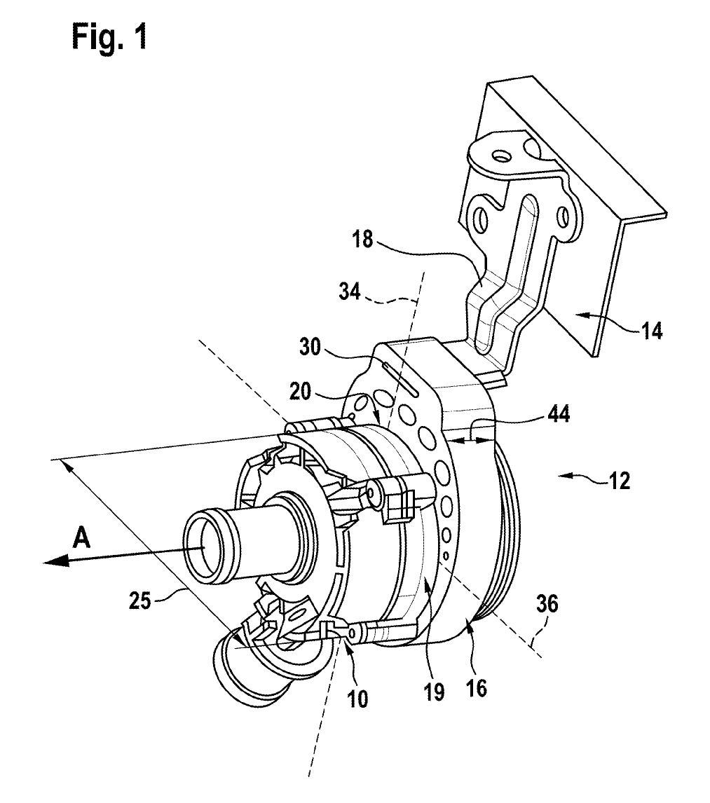

FIG. 1 shows an assembly 10 which can be attached via a holding device 12 in an installation space, in particular a motor vehicle 14. The assembly 10 may in particular be a pump, a coolant circuit pump, an electric motor, a fan or further components which are attached on and/or in a motor vehicle 14. As an example, in FIG. 1 the assembly 10 is configured as a pump or a cooling circuit pump. The motor vehicle 14 is shown in FIG. 1 in simplified depiction merely as an angular body part. Furthermore, in FIG. 1 the assembly 10 is shown as an example merely as a pump or a cooling circuit pump.

According to the invention, the holding device 12 comprises an elastomer mount 16 and the fixing element 18 via which the elastomer mount may be attached on the motor vehicle 14. As clearly evident from FIG. 1, the elastomer mount is formed so as to be substantially annular and has an inner region 20 in which the assembly 10 is pressed.

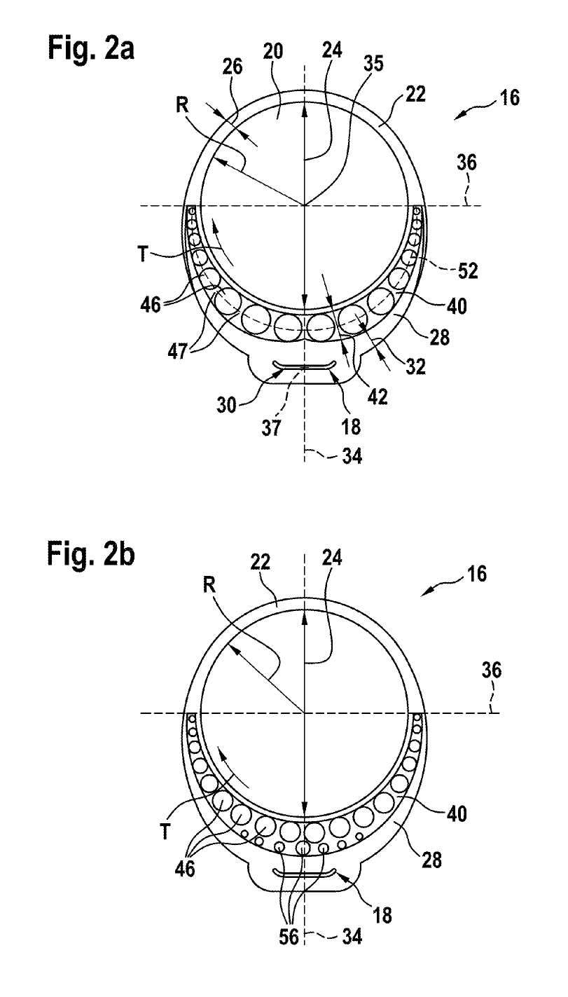

A pump of the type discussed here usually has an impeller which rotates at a speed of around 3750 rpm. Thus the pump according to the invention has a resonant frequency which lies around 500 Hz. Transmission of the resonant frequency and hence the undesirable transmission of sound from the pump into the motor vehicle interior takes place via the assembly 10 through the elastomer mount 16 to the fixing element 18 and finally to the motor vehicle 14. The elastomer mount 16 according to the invention shown in FIGS. 1 and 2 is, according to the invention, advantageously configured to minimize this noise formation. As well as noise minimization, a further object of the holding device 12 as a damping and decoupling element is to absorb dynamic loads, such as for example shaking and vibrational loads which may occur in operation of the motor vehicle. In addition, such a holding device 12 advantageously allows captive clamping of the assembly 10 with simultaneously a low necessary material usage for the elastomer mount 16.

FIG. 2a shows an embodiment of the elastomer mount 16 according to the invention from FIG. 1 in an enlarged depiction. FIG. 2a shows an elastomer mount 16 in top view.

As clearly evident from FIG. 2a, the elastomer mount 16 has a first holding element 22. The first holding element 22 is configured so as to be substantially annular and surrounds the assembly 10. As already stated, according to an embodiment of the invention, the assembly 10 is formed as a pump. Such a pump, as shown for example in FIG. 1, usually has a round cross-section in its receiving region 19. For captive fixing of the assembly 10 in the first holding element 22 of the elastomer mount 16, the first holding element 22 according to the invention has an inner region 20 of a shape adapted to the contour of the receiving region 19 of the assembly 10. In the embodiment of the elastomer mount 16 shown in FIGS. 1 to 3, the first holding element 22 is configured so as to be substantially annular, corresponding to the contour of the receiving region 19 of the pump.

According to an advantageous embodiment of the invention, as shown for example in FIG. 1, an optimal captive fixing of the assembly 10 in the elastomer mount 16 is achieved if the diameter 24 of the inner region 20 is dimensioned smaller than the diameter 25 of the assembly 10 in the receiving region 19. When the elastomer mount 16 is installed, it is therefore pushed onto the assembly 10 under preload. In this way, a radial pressure necessary for captive clamping is provided between the elastomer mount 16 and the assembly 10.

In the embodiment of the invention shown in FIG. 2a, the first holding element 22 has a material thickness 26 which increases as the distance from the fixing point 18 increases. Since the load moment applied to the first holding element 22 increases accordingly as the distance from the fixing element 18 increases, via such a first holding element 22, which has a material thickness 26 which increases as the distance from the fixing point 18 increases, an even radial pressure can be provided over the entire periphery of the assembly 10.

As well as the first holding element 22, the elastomer mount 16 according to the invention furthermore has a second holding element 28. The second holding element 28 serves in particular for connecting the assembly 10 to the fixing element 18, and by its shape and arrangement ensures adequate stability of the holding device 12, and hence also a smaller deflection of the assembly 10 in the installation space. According to the invention, the fixing element 18 of the holding device 10 is arranged on the second holding portion 28. To this end, the second holding portion 28 has a receiving slot 30. In mounted state, the corresponding fixing element 18, which may for example be configured as a curved fixing plate, can be pushed through the corresponding receiving slot 30 and locked.

As well as the embodiment of the receiving slot 30 shown in FIG. 2a, other embodiments of the fixing of the fixing element 18 on the elastomer mount 16 are conceivable. Thus for example two or more receiving slots 30 may be provided, which are arranged at a defined angle relative to each other. Furthermore, it is also conceivable that additional fixing means are provided for connecting the elastomer mount to the fixing element 18.

As clearly evident in FIG. 2a, the second holding element 28 has a material thickness 32 which decreases as the distance from the fixing element 18 or from the receiving slot 30 increases. The second holding element 28 is therefore also optimized for load under the peripheral condition of material saving. FIG. 2a shows an embodiment of the invention according to which the second holding element 28 has a substantially crescent-shaped cross-section.

To clarify the depiction of the arrangement of the first holding element 22 and second holding element 28 relative to each other, two theoretical straight lines 34 and 36 are drawn in FIG. 2a which extend in the sectional plane of the depiction from FIG. 2a. The first theoretical straight line 34, as clearly evident in FIG. 2a, passes through the center point 35 of the substantially circular inner region 20, and centrally through the receiving slot 30. The second theoretical straight line 36 stands orthogonally on the first theoretical straight line 34 and also passes through the center point 35 of the inner region 20.

As clearly shown from FIG. 2, the second holding element 28 is arranged symmetrically relative to the first theoretical straight line 34 so that forces can be transferred evenly to the receiving slot 30. According to the invention, a damping element 40 is arranged between the first holding element 22 and the second holding element 28. As clearly evident in FIG. 2a, the damping element 40 is arranged mainly in the region of the fixing element 18.

According to the embodiment of the invention shown in FIG. 2a, the damping element 40 also has a substantially crescent-shaped form for the purpose of being mainly arranged in the region of the fixing element 18 or receiving slot 30, i.e. the material thickness 42 of the damping element 40 continuously decreases as the distance from the fixing element 18 increases, and substantially runs into a point at its respective ends. In the embodiment of the invention shown in FIG. 2a, the damping element 40 is arranged only in the half of the elastomer mount 16 facing the fixing element 18 and delimited by the second straight line 36. However other embodiments are conceivable in which the damping portion 40 protrudes with one end or alternatively both ends over the second straight line 36. It is essential to the invention only that it is mainly arranged in the region of the fixing element 18.

According to the invention, the damping element 40 is distinguished in that it has a lower stiffness than the first holding element 22 and second holding element 28. Because of the reduced stiffness of the damping element 40, this is able to damp vibrations and shaking loads and ensure decoupling of sound transmissions. Since the vibrations of the assembly 10 do not propagate significantly from the regions remote from the fixing element 18 through the elastomer mount 16 to the fixing element 18, according to the invention the damping element 40 is arranged mainly in the region of the fixing element 18. In this way, advantageously, costly damping material can be saved.

To provide the damping and decoupling function, in the embodiment of the invention shown in FIG. 2a, the damping element 40 has first openings 46. It is expressly pointed out here that the lower stiffness of the damping element 14 compared with the holding elements 22, 28 may also or alternatively be provided by a variance of material properties. This may be achieved for example in that the damping element 40 contains softeners or other additives.

The first openings 46 according to the invention achieve a reduction in stiffness in all spatial directions. To illustrate these spatial directions, both the radial direction R and the tangential direction T are drawn in FIG. 2a. The axial direction A is shown in FIG. 1. By arranging the largest openings 46 in the region of the interface or fixing element 18, the decoupling is advantageously at its greatest at the point of the shortest transmission path from the assembly 10 or the pump into the motor vehicle 14.

According to a possible embodiment of the invention, the first openings 46 have a cross-section which decreases as the distance from the fixing element 18 increases. As clearly evident from FIG. 2a, the first openings 46 or the damping element 40, in the embodiment shown here, are arranged only in the half of the elastomer mount 16 assigned to the fixing element 18, wherein this half is delimited by the second theoretical straight line 36. It is however expressly pointed out here that the first openings 46 or the damping element 40 may extend beyond the second straight line 36. In other words, it is also conceivable that the damping element 40 and, additionally or alternatively, also the first openings 46 extend over more than half the periphery of the elastomer mount 16. It is essential to the invention here only that the majority of the first openings 46 are arranged in the region of the fixing element 18, wherein the term “majority of the first openings” does not refer to the purely numerical number of first openings 46 but to the surface area of the first openings 46.

As shown in FIG. 2a, according to a possible embodiment of the invention, the first openings 46 are formed circular. Such round openings 46 can advantageously easily be produced by means of extrusion. It is however pointed out here that other opening shapes 46 are conceivable. It is for example conceivable that the first openings 46 have a rectangular or trapezoid cross-section, whereby webs 47 arranged between the first openings 46 may advantageously be configured so as to be particularly elastic and hence the stiffness of the damping element 40 can be further reduced. As furthermore shown in FIG. 2a, the first openings 46 according to the embodiment shown here are arranged in with their centers on a theoretical semi-ellipse 52. According to the embodiment of the invention shown in FIG. 2a, the cross-section of these first openings 46 decreases continuously as the distance from the fixing element 18 along the theoretical semi-ellipse 52 increases.

As further shown in FIG. 2a, the first holding element 22 in the embodiment shown here surrounds at least portions of the damping element 40 and the second holding element 28 in the tangential direction T. According to an advantageous embodiment of the invention, the first holding element 22 and the second holding element 28 or the damping element 40 are here formed tapering crescent-like in opposite directions, so as to form together an elastomer mount 16 which has a substantially bend-free or jump-free contour in the transition region between the first holding element 22 and second holding element 28.

FIG. 2b shows a further embodiment of the elastomer mount 16 according to the invention in a radial section plane according to FIG. 2a, with the difference that the damping element 40 has additional second openings 56 as well as the first openings 46. As clearly shown in FIG. 2b, the second openings are arranged in the region of the fixing element 18 and thus lead to an advantageous reduction of stiffness of the damping element 40 in the region of the vibration transmission.

The second openings 56 in the embodiment shown in FIG. 2b also have a cross-section which decreases as the distance from the fixing element 18 increases. It is however expressly pointed out here that with, regard to the arrangement and design of the first openings 46 and second openings 56, many possible combinations are conceivable. Thus the second openings 56 may also be formed so as to be rectangular or trapezoid. Furthermore, it is also conceivable that the first openings 46 and, additionally or alternatively, also the second openings 56 have the same cross-section, and the reduced stiffness in the region of the fixing is provided because of the arrangement of the second openings 56 in the region of the fixing element 18. Furthermore, it is also conceivable that the first openings 46 and, additionally or alternatively, also the second openings 56 have a cross-section which decreases as the distance from the fixing 18 increases. It is essential to the invention only that the damping element 40 and hence the first openings 46 or second openings 56 are arranged mainly in the region of the fixing element, and the damping or decoupling effect diminishes as the distance the fixing element 18 increases.

The first openings 46 and second openings 56 according to FIGS. 2a and 2b are formed as continuous openings which extend over the entire axial length 44 of the elastomer mount 16. Such continuous openings 46, 56 can preferably be produced by means of extrusion. It is however also conceivable that the first openings 46 and, additionally or alternatively, also the second openings 56 may be formed as recesses open at the edge or as inclusions.

According to an advantageous embodiment of the invention, the elastomer mount is formed as one piece or integrally. The integral formation advantageously allows simple production by means of extrusion. Suitable materials for such an elastomer mount 16 produced by means of extrusion are in particular high-damping elastomer buffers which absorb the vibration energy and convert this into internal friction. In particular, EPDM (ethylene propylene diene monomer rubber) may advantageously be processed by means of extrusion, wherein by the addition of fillers or softeners, the properties can be adapted according to the given peripheral conditions.

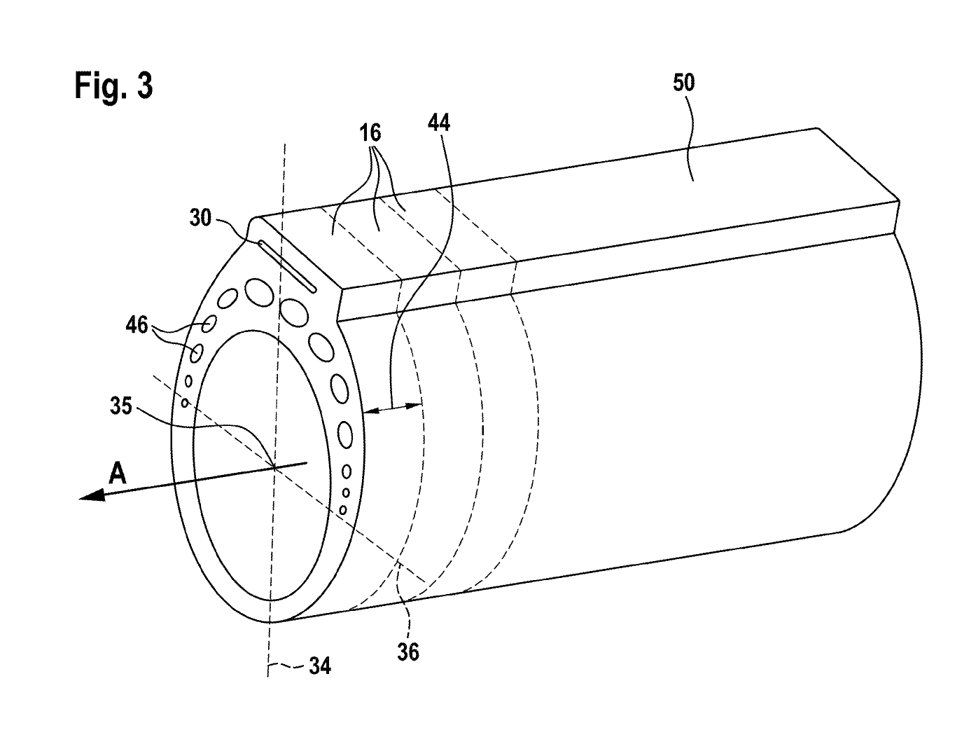

FIG. 3 shows a base body 50 produced by means of extrusion which, in a separation step following extrusion, is segmented into a plurality of elastomer mounts 16 according to the invention of axial length 44. In production of the elastomer mount 16 according to the invention, a base body 50 extending in the axial direction A and having the desired contour of the elastomer mount is extruded and shortened to the corresponding axial length 44 of the elastomer mount 16. Evidently, other shapes of elastomer mount may be extruded. It is here essential to the invention only that the base body 50 is extruded as an elongate hollow body extending in the axial direction A with an inner region 20 suitable for receiving the assembly 10, and in a subsequent separation step shortened to the desired axial length 44 of the elastomer mount 16.

1-13. (canceled)

14. A holding device (12) for fixing an assembly (10) to a motor vehicle (14), the holding device comprising an elastomer mount (16) and a fixing element (18) for attaching the elastomer mount (16) in an installation space, wherein the elastomer mount (16) comprises a substantially annular first holding element (22) and a second holding element (28), wherein the first holding element (22) has an inner region (20) configured to receive the assembly (10), and wherein the second holding element (28) is connected to the first holding element (22) by at least one damping element (40), and wherein the fixing element (18) is arranged on the second holding element (28), characterized in that the damping element (40) is arranged mainly in a region of the fixing element (18).

15. The holding device (12) according to claim 14, characterized in that a cross-section of the damping element (40) decreases as a distance from the fixing element (18) increases.

16. The holding device (12) according to claim 14, characterized in that the damping element (40) has a crescent-shaped cross-section and is arranged between the first holding element (22) and the second holding element (28).

17. The holding device (12) according to claim 14, characterized in that the first holding element (22) surrounds at least portions of the damping element (40) and/or the second holding element (28).

18. The holding device (12) according to claim 14, characterized in that the damping element (40) has a plurality of first openings (46), a cross-section of which decreases as a distance from the fixing element (18) increases.

19. The holding device (12) according to claim 18, characterized in that the first openings (46) have a substantially round cross-section.

20. The holding device (12) according to claim 18, characterized in that the first openings (46) are arranged along a theoretical semi-ellipse (52).

21. The holding device (12) according to claim 18, characterized in that second openings (56) are provided in the region of the fixing element (18).

22. The holding device (12) according to claim 21, characterized in that a cross-section of the second openings (56) decreases as the distance from the fixing element (18) increases.

23. The holding device (12) according to claim 14, characterized in that the second holding element (28) has a substantially crescent-shaped cross-section,

24. The holding device (12) according to claim 14, characterized in that the first holding element (22), the second holding element (28) and the damping element (40) are formed integrally of one piece.

25. The holding device (12) according to claim 14, characterized in that the elastomer mount (16) is produced by extrusion as a hollow body with an inner region (20) configured to receive the assembly (10).

26. An elastomer mount (16) for use in fixing an assembly to a motor vehicle, the elastomer mount comprising a substantially annular first holding element (22) and a second holding element (28), wherein the first holding element (22) has an inner region (20) which is configured to receive the assembly (10), and wherein the second holding element (28) is connected to the first holding element (22) by at least one damping element (40), and wherein the second holding element (28) has an interface for arrangement of a fixing element (18) for attaching the elastomer mount in an installation space, and the damping element (40) is arranged mainly in a region of the interface.

27. An apparatus comprising a pump (10) and a holding device (12) for fixing the pump (10) to a motor vehicle (14), the holding device including an elastomer mount (16) and a fixing element (18) for attaching the elastomer mount (16) in an installation space in the motor vehicle (14), wherein the elastomer mount (16) comprises a substantially annular first holding element (22) and a second holding element (28), wherein the first holding element (22) has an inner region (20) receiving the pump (10), and wherein the second holding element (28) is connected to the first holding element (22) by at least one damping element (40), and wherein the fixing element (18) is arranged on the second holding element (28), characterized in that the damping element (40) is arranged mainly in a region of the fixing element (18).
